(19) United States
(12) Patent Application Publication
(10) Pub. No.: US 2015/0187044 A1
(43) Pub. Date: Jul. 2, 2015

(54) GRAPHICS RENDERING DEVICE

(71) Applicant: Mitsubishi Electric Corporation, Chiyoda-ku, Tokyo (JP)

(72) Inventors: Akira Torii, Chiyoda-ku (JP); Yoshiyuki Kato, Chiyoda-ku (JP)

(73) Assignee: Mitsubishi Electric Corporation, Chiyoda-ku, Tokyo (JP)

(21) Appl. No.: 14/423,601

(22) PCT Filed: Sep. 25, 2013
(86) PCT No.: PCT/JP13/75809

§ 371 Date: Feb. 24, 2015

(30) Foreign Application Priority Data
Sep. 27, 2012 (JP) 2012-213533

(51) Int. Cl. G06T 1/60

(52) U.S. Cl. CPC G06T 1/60

(57) ABSTRACT

Graphic form data of a rendering graphic form and a rendering list for defining the specifics of rendering out of an external memory, where the graphic form data and the rendering list are stored in advance, to generate intermediate data and store the intermediate data in the external memory with the use of intermediate data generation means. Intermediate data scanning means detects a graphic form from the intermediate data stored in the external memory. Graphic form rendering means generates pixels of the detected graphic form from the graphic form data stored in the external memory to render an image. The rendering image is written and held in a buffer that has a multi-buffer configuration. Display output means reads the rendering image stored in the buffer and outputs the read rendering image to a display device. The writing in the buffer and the reading out of the buffer are executed alternatingly.

### TECHNICAL FIELD

The present invention relates to a graphics rendering device for rendering a graphic form image and transferring the image to a display device.

### BACKGROUND ART

In a method common among graphics rendering devices that render and display a graphic form, a frame buffer bandwidth is secured in an external memory, pixels constituting a graphic form are rendered in the frame buffer to create an image, and the image in the frame buffer is transferred to a display device to display a screen. In another common method, the frame buffer is given a double-buffer configuration in order not to display on a display screen an image that is in the middle of being rendered, and a rendering screen is switched to the display screen after rendering a screen of images (a frame of images) is finished.

JP 2009-15248 A (Patent Literature 1) proposes a method of reducing memory access when a double buffer is employed by selecting from the two buffers for each bandwidth separately, and executing write and read in the selected buffer.

### CITATION LIST

### Patent Literature

[PTL 1] JP 2009-15248 A

### SUMMARY OF INVENTION

### Technical Problems

With the method of Patent Literature 1 and other methods in the related art where a graphic form is rendered in a frame buffer in an external memory and the rendered graphic form is read out of the frame buffer to be displayed, data read/write in the external memory is frequent and memory bandwidth consumption (a necessary data transfer amount) is accordingly large. Processing of reading and transferring the frame buffer to a display device is executed all the time at a refresh rate of, for example, sixty frames per second, and therefore occupies a certain memory bandwidth. In addition, rendering in the frame buffer requires, in the case of translucent processing, for example, read-modify-write processing, thus consuming a large memory bandwidth. Further, the memory bandwidth necessary for those processing procedures is in proportion to resolution and color count (the number of bits per pixel), and securing a memory bandwidth to display a graphic form in high resolution and in many colors therefore requires using a high-speed external memory or configuring an external memory from a plurality of chips, which gives rise to a problem of high cost.

The present invention has been made to solve the problems described above, and an object of the present invention is therefore to provide a graphics rendering device that eliminates the need for a frame buffer in an external memory and consumes a small memory bandwidth in the process of rendering and displaying graphics.

### Solution to Problems

According to one embodiment of the present invention, there is provided a graphics rendering device configured to render graphics and display the graphics on a screen, including: intermediate data generating means for reading graphic form data of a graphic form to be rendered and a rendering list that defines specifics of rendering, out of an external memory in which the graphic form data and the rendering list are stored in advance, generating intermediate data, and storing the generated intermediate data in the external memory; intermediate data scanning means for detecting a graphic form from the intermediate data stored in the external memory; graphic form rendering means for rendering a rendering image by generating, from the graphic form data stored in the external memory, pixels of the graphic form that has been detected by the intermediate data scanning means; a buffer that has a multi-buffer configuration for holding the rendering image that has been rendered by the graphic form rendering means, in order to execute alternatingly the rendering of a rendering image and the reading of the rendering image that has been rendered; and display output means for outputting a rendering image that is stored in the buffer in order to display the rendering image on a display device.

### Advantageous Effects of Invention

The graphics rendering device according to one embodiment of the present invention has a configuration in which graphic form data of a rendering graphic form and a rendering list for defining the specifics of rendering are read out of the external memory to generate intermediate data with the use of the intermediate data generating means, the intermediate data scanning means detects a graphic form from the intermediate data, a rendering image of the detected graphic form is generated from the graphic form data by the graphic form rendering means to be held in the buffer that has the multi-buffer configuration, and the rendering image stored in the buffer is output to the display device by the display output means. The graphics rendering device according to one embodiment of the present invention therefore does not need a frame buffer in an external memory and has an effect of reducing memory consumption. The effect of reducing memory bandwidth consumption is particularly prominent for vector graphic forms, which are small in data amount.

### BRIEF DESCRIPTION OF DRAWINGS

FIG. 1 is a configuration diagram of a graphics rendering device according to a first embodiment of the present invention.

FIG. 2 is a diagram illustrating graphic forms that are rendered according to the first embodiment of the present invention.

FIG. 3 is a diagram showing a structural example of vector graphic form data.

FIG. 4 is a diagram showing a structural example of bit map image data.

FIG. 5 is a diagram showing an example of a rendering list which is made up of pieces of data each defining a rendering method for a graphic form.

FIG. 6 is a diagram showing an example of a rendering list that has a hierarchical structure.

FIG. 7 is a diagram showing a structural example of intermediate data which is created by an intermediate data generating part.

FIG. 8 is an explanatory diagram of a case where an intermediate data scanning part renders with the topmost scan line on a screen as a target.

FIG. 9 is an explanatory diagram of a case where the intermediate data scanning part renders with a scan line that is second from the top on the screen as a target.

FIG. 10 is an explanatory diagram of a case where the intermediate data scanning part executes rendering processing with the last (lowermost on the screen) scan line as a target.

FIG. 11 is an explanatory diagram of timing of intermediate data creating processing, scan line rendering processing, and display output processing.

FIG. 12 is an explanatory diagram of a processing method in which the creation of intermediate data is staggered from scan line-by-scan line rendering and display processing by one frame when an intermediate data memory bandwidth in an external memory has a double-buffer configuration.

FIG. 13 is an explanatory diagram of a processing method for a case where creating intermediate data is executed once for every two frames.

FIG. 14 is an explanatory diagram of a rendering and display processing method for a case where a line buffer has a double-buffer configuration for holding four lines of images.

FIG. 15 is a configuration diagram of a graphics rendering device according to a third embodiment of the present invention.

### DESCRIPTION OF EMBODIMENTS

### First Embodiment

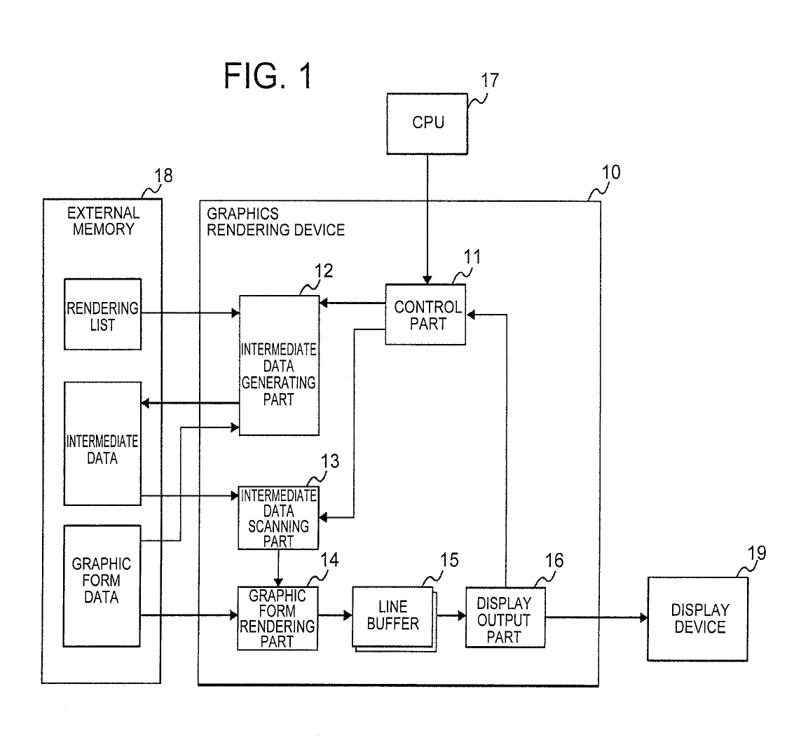

FIG. 1 is a configuration diagram illustrating a graphics rendering device according to a first embodiment of the present invention.

In FIG. 1, reference numeral 10 denotes the graphics rendering device; 11, a control part for controlling rendering; 12, an intermediate data generating part for generating intermediate data from a rendering list or a rendering command and from graphic form data; 13, an intermediate data scanning part for detecting a graphic form that is included in a scan line of a processing target; 14, a graphic form rendering part for rendering a rendering image by generating pixels from graphic form data; 15, a line buffer having a double-buffer configuration that holds one line of rendering images; 16, a display output part for reading a rendering image out of the line buffer 15 and outputting the image; 17, a central processing unit (CPU) for issuing an instruction to the graphics rendering device 10; 18, an external memory for storing and holding a rendering list, graphic form data, and intermediate data; and 19, a display device for displaying a screen.

Operation is described next.

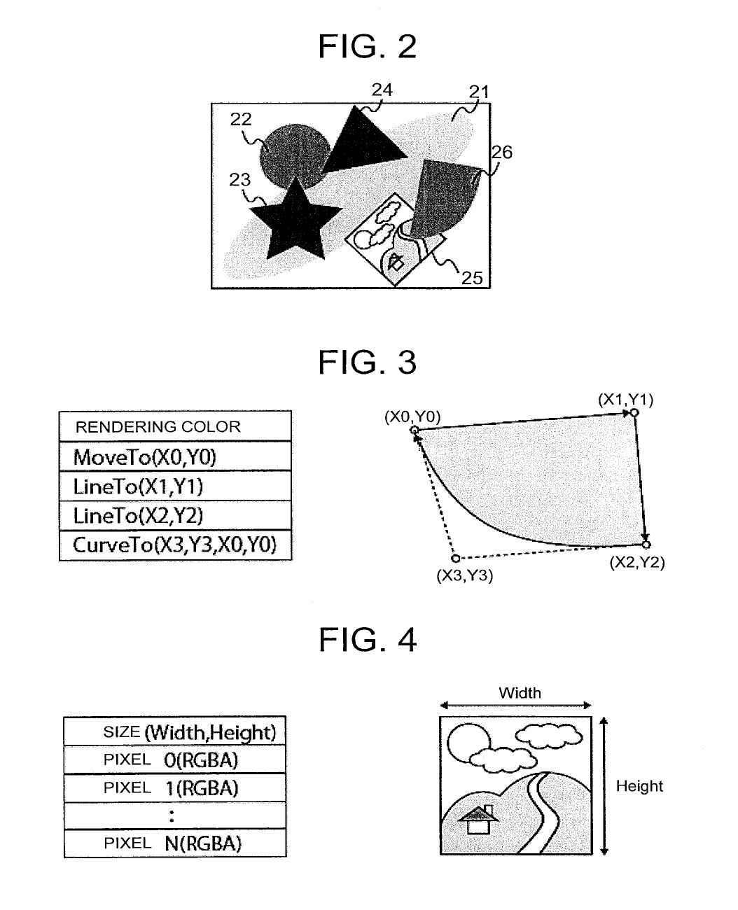

The operation described here is of rendering by separately magnifying, reducing, and rotating graphic forms 21, 22, 23, 24, 25, and 26, which are illustrated in FIG. 2 as an example.

First, the CPU 17 stores, in advance, graphic form data of a vector graphic form or of a bit map image in a graphic form data memory bandwidth of the external memory 18.

FIG. 3 shows an example of the structure of vector graphic form data. A vector graphic form is a graphic form outline constructed from straight lines and Bezier curves, and vector form data defines an outline with commands (“Move To” and “Line To”) and the XY coordinate values of vertices or control points. Vector form data also includes data that specifies a color in which the graphic form is rendered. FIG. 4 shows an example of the structure of bit map image data. Bit map image data includes an image size and the color value (RGBA value) of each pixel.

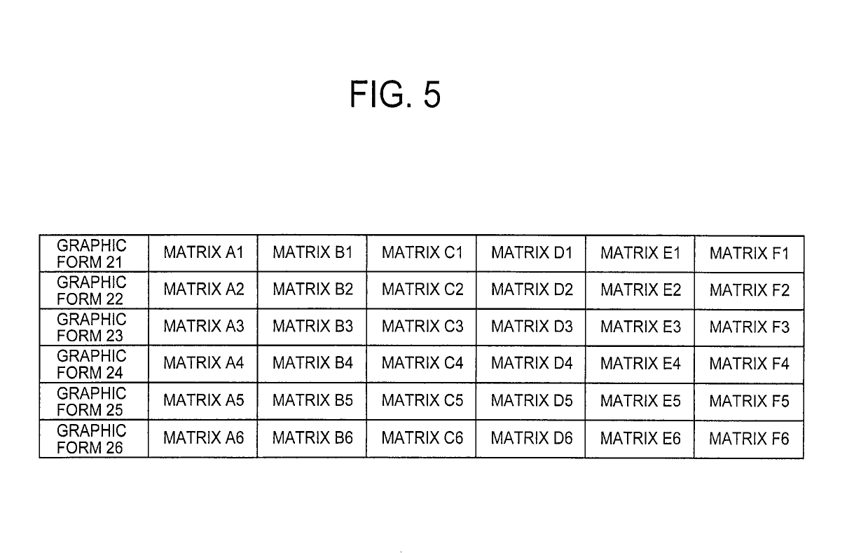

The CPU 17 also stores, in advance, a rendering list for rendering one frame in a rendering list memory bandwidth of the external memory 18. FIG. 5 shows an example of the structure of the rendering list. The rendering list is data for defining what graphic form (a vector graphic form or a bit map image) is rendered and how the graphic form is rendered. What graphic form is rendered is specified by a pointer to a piece of graphic form data, and how the graphic form is rendered is specified by a transformation matrix. The transformation matrix in this example is a 3×2 matrix, and dictates a coordinate transformation such as magnification, reduction, rotation, or a parallel shift by applying the following expression to the XY coordinates of vertices or control points of a vector graphic form, or the XY coordinates of the four corners of a bit map image.

$$( \begin{matrix}Xnew \\ Ynew\end{matrix} ) = ( \begin{matrix}A & B & C \\ D & E & F\end{matrix} ) \cdot ( \begin{matrix}X \\ Y \\ 1\end{matrix} ) \qquad [ Mathematical Expression 1 ]$$

The rendering list includes all objects to be rendered in one frame. The objects rendered in the example of FIG. 2 are six graphic forms, the graphic forms 21, 22, 23, 24, 25, and 26, and the rendering list for this rendering is therefore made up of pointers and transformation matrices that are respectively associated with the graphic forms 21, 22, 23, 24, 25, and 26 as shown in FIG. 5. The graphic forms are rendered in the order of listing, with the graphic form at the top of the rendering list rendered first.

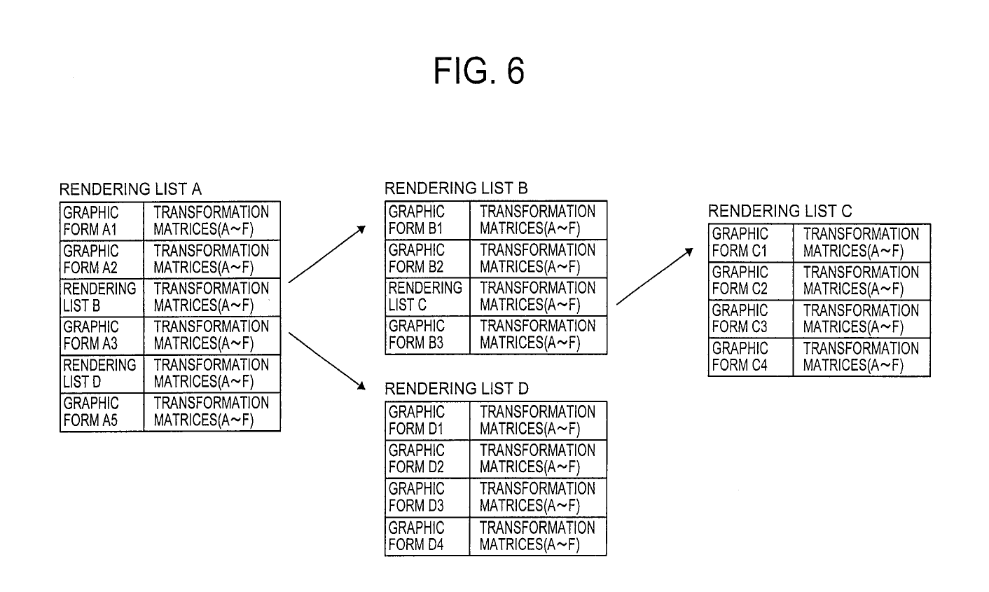

The rendering list may have a hierarchical structure as shown in FIG. 6. The rendering list may also be in a format that defines a series of rendering commands, such as a display list of Open Graphics Library (OpenGL), which is a three-dimensional graphics application program interface (API).

After storing the graphic form data and the rendering list which are necessary for rendering in the graphic form data memory bandwidth and rendering list memory bandwidth of the external memory 18, respectively, the CPU 17 instructs the graphics rendering device 10 to start rendering. The graphics rendering device 10 thus starts processing of one frame of images. The control part 11 instructs the intermediate data generating part 12 to start processing in time with the start of a vertical blank period of the display output part 16.

The intermediate data generating part 12 receives the instruction from the control part 11 and starts processing by reading the rendering list out of the rendering list memory bandwidth of the external memory 18.

The intermediate data generating part 12 first reads the graphic form data specified by the rendering list, and performs coordinate transformation processing by using transformation matrices that are specified by the rendering list on the XY coordinates of vertices or control points. Specifically, the intermediate data generating part 12 performs coordinate transformation processing by using transformation matrices (matrices A1, B1, C1, D1, E1, and F1) on the XY coordinates of vertices or control points of the vector graphic form data of the graphic form 21. In executing this processing, the intermediate data generating part 12 determines a minimum value and maximum value of the Y coordinates after the coordinate transformation, and holds the values as rendering range information.

After finishing the coordinate transformation processing for all of the vertices or control points of the graphic form 21, the intermediate data generating part 12 writes the pointer to the graphic form 21, the transformation matrices specified by the rendering list, and the rendering range information (the minimum value and maximum value of the Y coordinates) in an intermediate data memory bandwidth of the external memory 18 as intermediate data.

The intermediate data generating part 12 then reads the next item on the rendering list and performs the same processing on the graphic form 22. Specifically, the intermediate data generating part 12 reads graphic form data of the graphic form 22, and performs coordinate transformation processing by using transformation matrices (matrices A2, B2, C2, D2, E2, and F2) on the XY coordinates of vertices or control points. After finishing the coordinate transformation processing for all of the vertices or control points of the graphic form 22, the intermediate data generating part 12 writes the pointer to the graphic form 22, the transformation matrices specified by the rendering list, and the rendering range information (the minimum value and maximum value of the Y coordinates) in the intermediate data memory bandwidth of the external memory 18 as intermediate data.

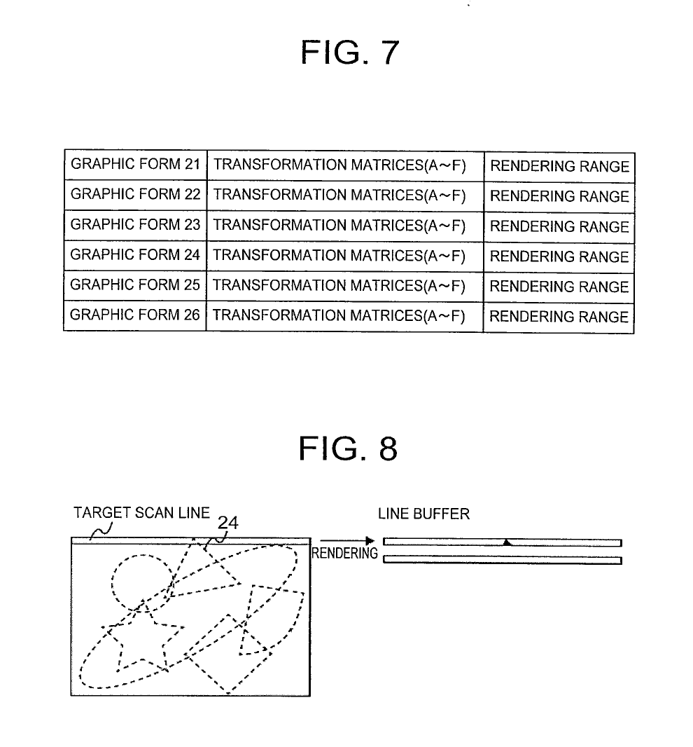

The intermediate data generating part 12 keeps reading the rendering list in a similar manner to the last item on the list, thereby creating in the intermediate data memory bandwidth of the external memory 18 intermediate data in which information about pieces of graphic form data of all graphic forms necessary to be rendered in one frame is registered. FIG. 7 shows an example of the structure of intermediate data. The processing of creating intermediate data is executed in a vertical blank period that precedes the transition to the processing of the next frame.

In the case where the rendering list has a hierarchical structure, transformation matrices specified when a lower-level rendering list is called up from an upper-level rendering list are multiplied by transformation matrices specified for the respective graphic forms on the lower-level rendering list, and transformation matrices obtained as a result of the multiplication are used to perform coordinate transformation processing on the XY coordinates of vertices or control points of the graphic form data.

Thereafter, the control part 11 issues an instruction to the intermediate data scanning part 13 to start processing on a scan line-by-scan line basis, in time with a horizontally synchronized output from the display output part 16 to the display device 19.

The control part 11 first instructs the intermediate data scanning part 13 to render with the topmost scan line on the screen as a target. FIG. 8 is a diagram illustrating rendering processing in which the topmost scan line is the target.

Receiving the instruction from the control part 11, the intermediate data scanning part 13 reads intermediate data out of the intermediate data memory bandwidth of the external memory 18, and refers to the rendering range information to determine whether or not the graphic form data is included in the processing target scan line. In the case where the graphic form data is included in the processing target scan line, the intermediate data scanning part 13 outputs a pointer to the graphic form data and transformation matrices to the graphic form rendering part 14, and instructs the graphic form rendering part 14 to render. In the example of FIG. 8, where the graphic form 24 is included in the processing target scan line, the intermediate data scanning part 13 instructs the graphic form rendering part 14 to render the graphic form 24.

The graphic form rendering part 14 receives the instruction from the intermediate data scanning part 13 and reads the graphic form data out of the graphic form data memory bandwidth of the external memory 18. After transformation through coordinate transformation processing performed on the XY coordinates of vertices or control points of the read graphic form data with the use of specified transformation matrices, the graphic form rendering part 14 generates pixel data for the processing target scan line and renders in the line buffer 15. Generating individual pieces of pixel data from graphic form data is performed by a known method, and a description thereof is omitted.

At the time the intermediate data of every graphic form is scanned and rendering is finished for all pieces of graphic form data included in the processing target scan line (only the graphic form 24 in the example of FIG. 8), an image of this scan line is completed in the line buffer 15.

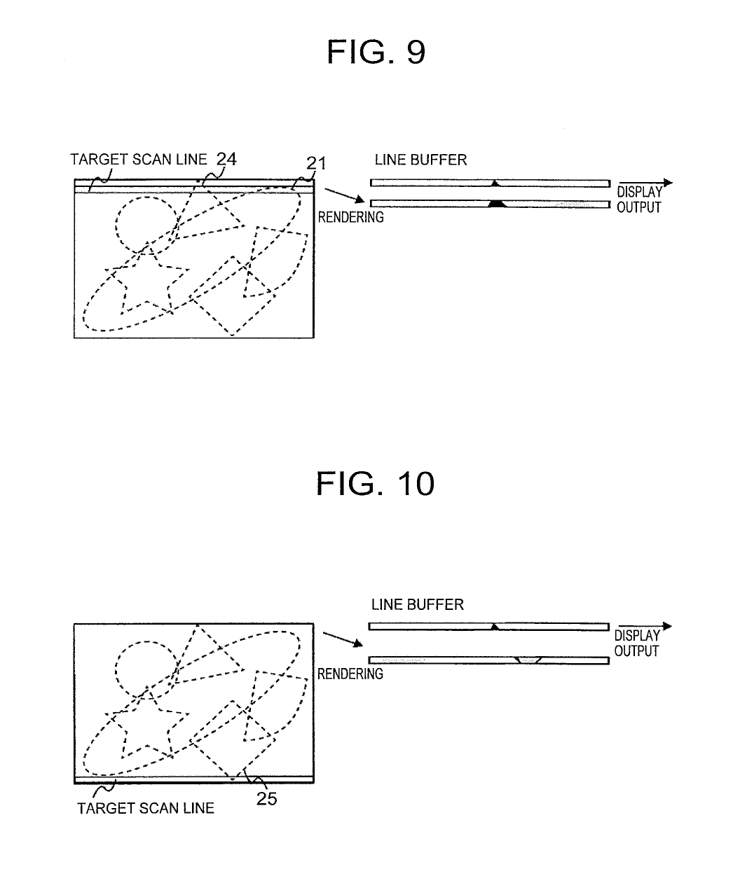

The display output part 16 switches between a rendering-side buffer and a display-side buffer of the line buffer 15, which has a double-buffer configuration, at the timing of horizontal synchronization. When a switch is made from the rendering-side buffer to the display-side buffer, the display output part 16 reads images out of the display-side buffer and starts transferring one line of images to the display device 19. At the same time, the control part 11 instructs the intermediate data scanning part 13 to render with a scan line that is second from the top on the screen as a target. FIG. 9 is a diagram illustrating processing in which the second-from-the-top scan line on the screen is the target.

Receiving the instruction from the control part 11, the intermediate data scanning part 13 reads intermediate data out of the intermediate data memory bandwidth of the external memory 18, and refers to the rendering range information to determine whether or not the graphic form data is included in the processing target scan line. In the case where the graphic form data is included in the processing target scan line, the intermediate data scanning part 13 outputs a pointer to the graphic form data and transformation matrices to the graphic form rendering part 14, and instructs the graphic form rendering part 14 to render. In the example of FIG. 9, where the graphic form 21 and the graphic form 24 are included in the processing target scan line, the intermediate data scanning part 13 instructs the graphic form rendering part 14 to render the graphic form 21 and the graphic form 24.

The graphic form rendering part 14 receives the instruction from the intermediate data scanning part 13 and reads the graphic form data out of the graphic form data memory bandwidth of the external memory 18. After transformation through coordinate transformation processing performed on the XY coordinates of vertices or control points of the read graphic form data with the use of specified transformation matrices, the graphic form rendering part 14 generates pixel data for the processing target scan line and renders in the line buffer 15. This rendering is executed in the rendering-side buffer which is not being read by the display output part 16, out of the line buffer 15 having a double-buffer configuration.

At the time the intermediate data of every graphic form is scanned and rendering is finished for all pieces of graphic form data included in the processing target scan line (the graphic form 21 and the graphic form 24 in the example of FIG. 9), an image of this scan line is completed in the line buffer 15.

The third scan line from the top and subsequent scan lines are processed in the same manner. FIG. 10 is a diagram illustrating processing in which the last (lowermost on the screen) scan line is the target.

As in the description given above, the intermediate data scanning part 13 reads intermediate data out of the intermediate data memory bandwidth of the external memory 18, and refers to the rendering range information to determine whether or not the graphic form data is included in the processing target scan line. In the example of FIG. 10, where the graphic form 25 is included in the processing target scan line, the intermediate data scanning part 13 instructs the graphic form rendering part 14 to render the graphic form 25.

The graphic form rendering part 14 receives the instruction from the intermediate data scanning part 13 and reads the graphic form data out of the graphic form data memory bandwidth of the external memory 18. After transformation through coordinate transformation processing performed on the XY coordinates of vertices or control points of the read graphic form data with the use of specified transformation matrices, the graphic form rendering part 14 generates pixel data for the processing target scan line and renders in the line buffer 15. This rendering is executed in a buffer that is not being read by the display output part 16, out of the line buffer 15 having a double-buffer configuration.

At the time the intermediate data of every graphic form is scanned and rendering is finished for all pieces of graphic form data included in the processing target scan line (only the graphic form 25 in the example of FIG. 10), an image of this scan line is completed in the line buffer 15.

The display output part 16 reads the image of the last scan line out of the line buffer 15 and transfers the read image to the display device 19, thereby completing screen display of one frame of images.

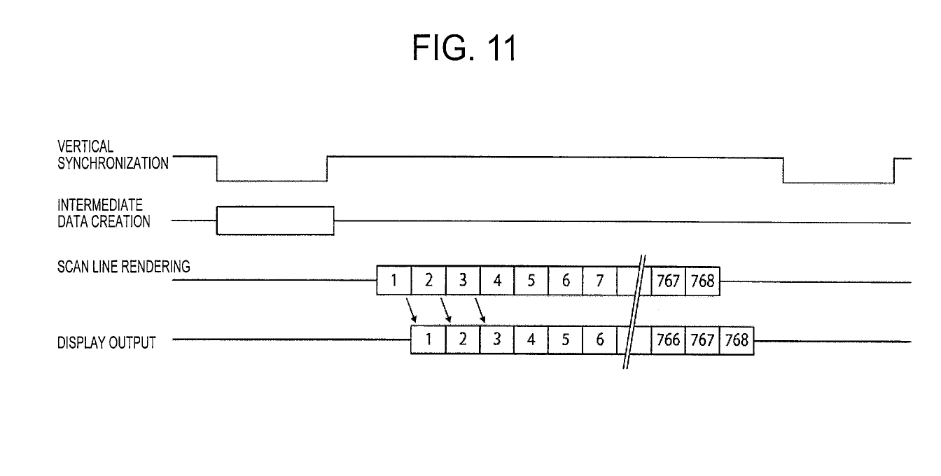

In this manner, a screen is displayed by scanning intermediate data one scan line at a time to detect a graphic form that is included in the target scan line, reading graphic form data of the detected graphic form to render an image in the line buffer 15, and outputting the image in the line buffer 15 to the display device 19. FIG. 11 is a diagram showing processing timing. FIG. 11 shows an example for the case where the vertical resolution of the display device 19 is 768.

As described above, this embodiment is configured so that an image is generated from graphic form data to be output to the display device for each scan line separately, thereby eliminating the need for a frame buffer in an external memory. This embodiment thus has an effect of reducing memory bandwidth consumption. The effect of reducing memory bandwidth consumption is particularly prominent for vector graphic forms, which are small in data amount.

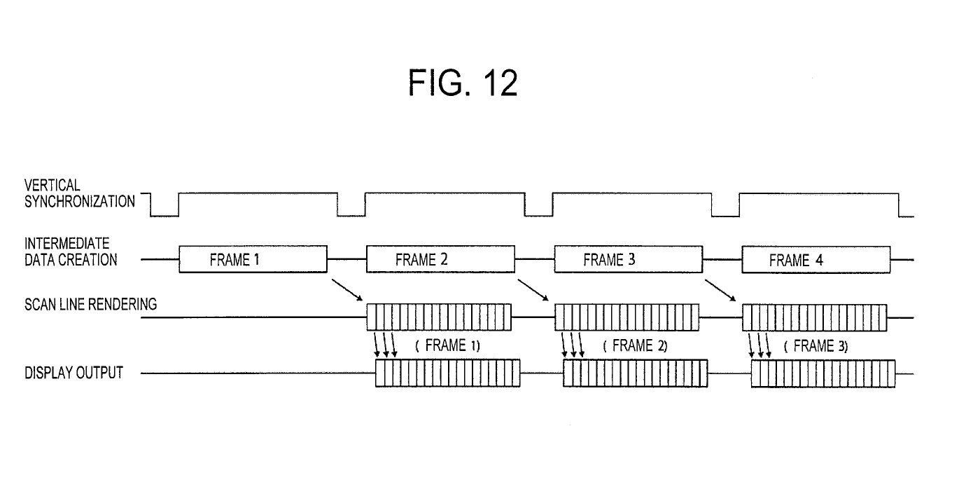

The intermediate data memory bandwidth in the external memory may have a double-buffer configuration so that, as shown in FIG. 12, the processing executed by the intermediate data generating part 12 to create intermediate data from the rendering list and graphic form data is staggered by one frame from the processing executed by the intermediate data scanning part 13 and the graphic form rendering part 14 to render scan line by scan line and the display processing executed by the display output part 16.

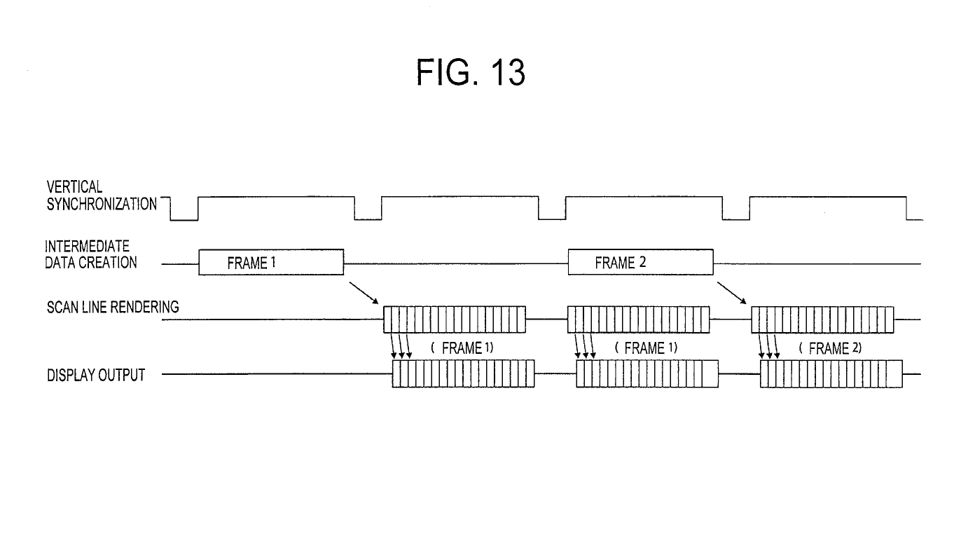

When updating what is displayed on a frame-by-frame basis is unnecessary, the processing of creating intermediate data from the rendering list and graphic form data which is performed by the intermediate data generating part 12 may be executed once for every two or more frames as shown in FIG. 13, with the intermediate data scanning part 13, the graphic form rendering part 14, and the display output part 16 using the same intermediate data repeatedly for the duration of the plurality of frames.

The first embodiment describes a method in which the intermediate data scanning part and the graphic form rendering part process lines by scan processing. However, those processing procedures are not limited to the method in which lines are scanned, and other existing methods may be employed as long as detecting a graphic form and rendering a rendering image of the detected graphic form can be executed for each of a plurality of pieces into which one frame is broken, separately. The buffer is also not limited to line buffers, and any buffer that suits the processing method in which a graphic form is detected and a rendering image of the detected graphic form is rendered may be employed.

### Second Embodiment

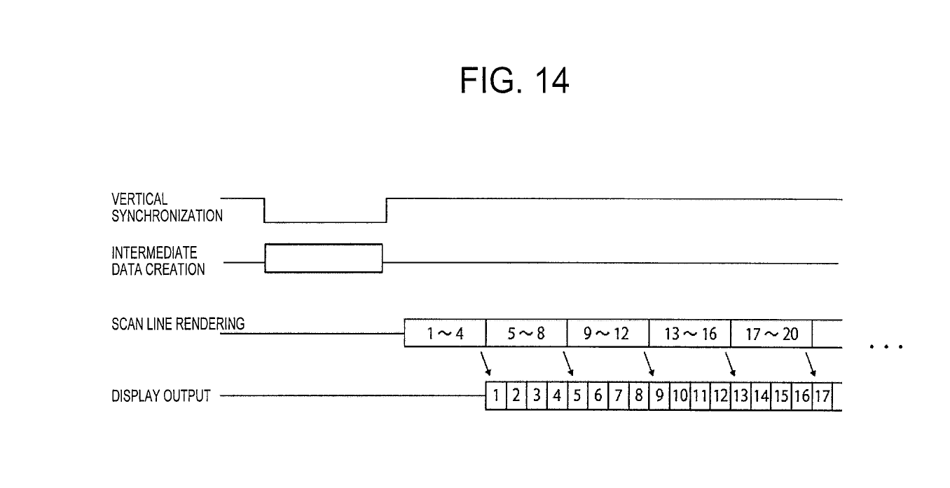

While the first embodiment is an example of the line buffer 15 having a double-buffer configuration that holds one line of images, the line buffer 15 may be configured so as to hold a plurality of lines of images. The operation in the case where the line buffer 15 is configured so as to hold four lines of images is described below as an example. FIG. 14 is a diagram showing processing that is executed to render and display in this case.

The CPU 17 stores the graphic form data and the rendering list in the graphic form data memory bandwidth and the rendering list memory bandwidth of the external memory 18, respectively, and instructs the graphics rendering device 10 to start rendering. The intermediate data generating part 12 creates in the intermediate data memory bandwidth of the external memory 18 intermediate data in which information about pieces of graphic form data of all graphic forms necessary to be rendered in one frame is registered. The operation in the second embodiment up through this point is the same as the one in the first embodiment.

Thereafter, the control part 11 issues a processing start instruction to the intermediate data scanning part 13 at a rate of once for every four horizontally synchronized outputs from the display output part 16 to the display device 19.

The control part 11 first instructs the intermediate data scanning part 13 to render with the top four scan lines on the screen as targets. Receiving the instruction from the control part 11, the intermediate data scanning part 13 reads intermediate data out of the intermediate data memory bandwidth of the external memory 18, and refers to the rendering range information to determine whether or not the graphic form data is included in the four processing target scan lines. When the graphic form data is included in the four processing target scan lines, the intermediate data scanning part 13 outputs a pointer to the graphic form data and transformation matrices to the graphic form rendering part 14, and instructs the graphic form rendering part 14 to render.

The graphic form rendering part 14 receives the instruction from the intermediate data scanning part 13 and reads the graphic form data out of the graphic form data memory bandwidth of the external memory 18. After transformation through coordinate transformation processing performed on the XY coordinates of vertices or control points of the read graphic form data with the use of specified transformation matrices, the graphic form rendering part 14 generates pixel data for the four processing target scan lines and renders in the line buffer 15.

At the time the intermediate data of every graphic form is scanned and rendering is finished for all pieces of graphic form data included in the four processing target scan lines, images of the four scan lines are completed in the line buffer 15.

The display output part 16 switches between a rendering-side buffer and a display-side buffer of the line buffer 15, which has a double-buffer configuration, at a rate of once for every four horizontally synchronized outputs. When a switch is made from the rendering-side buffer to the display-side buffer, the display output part 16 reads images out of the display-side buffer and starts transferring four lines of images to the display device 19. At the same time, the control part 11 instructs the intermediate data scanning part 13 to render with the next four scan lines on the screen as targets.

In this manner, a screen is displayed by scanning intermediate data for every two or more scan lines to detect a graphic form that is included in the plurality of target scan lines, reading graphic form data of the detected graphic form to render an image in the line buffer 15, and outputting the image in the line buffer 15 to the display device 19. Processing a plurality of scanning lines at once reduces the number of times the intermediate data scanning part 13 executes the determining processing and the number of times graphic form data is read by the graphic form rendering part 14 as compared to when one scanning line is processed at a time, and therefore has an effect of further reducing memory bandwidth consumption.

### Third Embodiment

While the first embodiment and the second embodiment are examples of the line buffer 15 having a double-buffer configuration that has a rendering-side buffer and a display-side buffer, the line buffer 15 is not limited to double-buffer configurations, and may be configured so as to switch among three or more buffers. The operation in this case is described below.

The CPU 17 stores the graphic form data and the rendering list in the graphic form data memory bandwidth and the rendering list memory bandwidth of the external memory 18, respectively, and instructs the graphics rendering device 10 to start rendering. The intermediate data generating part 12 creates in the intermediate data memory bandwidth of the external memory 18 intermediate data in which information about pieces of graphic form data of all graphic forms necessary to be rendered in one frame is registered. The operation in the third embodiment up through this point is the same as the ones in the first embodiment and the second embodiment.

Thereafter, the control part 11 issues a processing start instruction to the intermediate data scanning part 13 in time with a horizontally synchronized output from the display output part 16 to the display device 19 as described in the first embodiment and the second embodiment. The graphic form rendering part 14 generates an image in the line buffer 15. The display output part 16 selects, at the timing of the horizontal synchronization, a buffer out of which an image is to be read, reads an image, and starts transferring the read image to the display device 19.

In this operation, when the graphic form rendering part 14 finishes generating an image in the line buffer 15, the control part 11 instructs the intermediate data scanning part 13 to render an image of the next scan line in the next buffer of the line buffer 15. Specifically, in the case of a triple-buffer configuration which has three buffers, the control part 11 issues an instruction to render sequentially in two buffers except for a buffer that is being read by the display output part 16. Similarly, in the case of a buffer configuration that has four buffers, the control part 11 issues an instruction to render sequentially in three buffers except for a buffer that is being read by the display output part 16.

In this manner, the line buffer 15 is constructed from three or more buffers and an image is rendered sequentially in the plurality of buffers minus the buffer that is being read for display output. The resultant effect is a decreased chance for wrong screen display due to complicate contents that cause heavy rendering processing load on the line buffer 15 and a delay in rendering processing.

### Fourth Embodiment

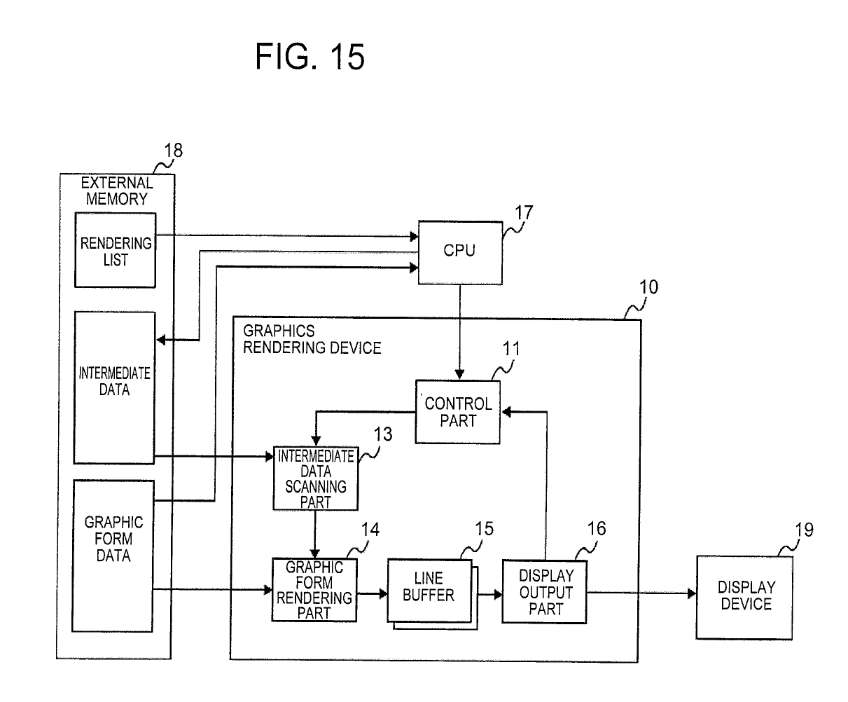

FIG. 15 is a configuration diagram illustrating a graphics rendering device according to a fourth embodiment of the present invention.

In this embodiment, the intermediate data generating part 12 in the first embodiment, the second embodiment, and the third embodiment is omitted, and processing of creating intermediate data is executed through software processing by the CPU 17.

Operation is described next.

In executing rendering, the CPU 17 performs the same processing as that of the intermediate data generating part 12 in the first embodiment, the second embodiment, and the third embodiment, by creating intermediate data from the rendering list and the graphic form data, and storing the created intermediate data in the external memory 18. After finishing creating one frame of intermediate data, the CPU 17 instructs the graphics rendering device 10 to start rendering. The graphics rendering device 10 thus starts processing of one frame of images.

Thereafter, the intermediate data scanning part 13 detects, for each scan line separately, a graphic form that is included in the scan line from intermediate data of the external memory 18, in time with a horizontally synchronized output from the display output part 16 to the display device 19. The graphic form rendering part generates pixels of the detected graphic form from the graphic form data of the external memory to render an image, and the rendering image is held in the line buffer 15. The rendering image stored in the line buffer 15 is output to the display device 19.

To change what is displayed, the CPU 17 creates new intermediate data, stores the new intermediate data in the external memory 18, and instructs the graphics rendering device 10 to render with the use of the new intermediate data.

### INDUSTRIAL APPLICABILITY

The graphics rendering device according to the present invention is capable of rendering that includes the magnification, reduction, rotation, and parallel shift of a graphic form via a coordinate transformation instruction, and consumes less memory bandwidth than graphics rendering devices of the related art. The graphics rendering device of the present invention can therefore be applied to visual expression in media and contents such as publishing, advertisement, printing, and video games.

1. A graphics rendering device configured to render graphics and display the graphics on a screen, comprising:
intermediate data generating means for reading graphic form data of a graphic form to be rendered and a rendering list that defines specifics of rendering, out of an external memory in which the graphic form data and the rendering list are stored in advance, generating intermediate data, and storing the generated intermediate data in the external memory;
intermediate data scanning means for detecting a graphic form from the intermediate data stored in the external memory;
graphic form rendering means for rendering a rendering image by generating, from the graphic form data stored in the external memory, pixels of the graphic form that has been detected by the intermediate data scanning means;
a buffer that has a multi-buffer configuration for holding the rendering image that has been rendered by the graphic form rendering means, in order to execute alternatingly the rendering of a rendering image and the reading of the rendering image that has been rendered; and
display output means for outputting a rendering image that is stored in the buffer in order to display the rendering image on a display device.

2. A graphics rendering device according to claim 1, wherein the intermediate data comprises a pointer to graphic form data of a graphic form to be rendered, transformation matrices for coordinate transformation processing of the graphic form to be rendered, and rendering range information of the graphic form to be rendered.

3. A graphics rendering device according to claim 1,
wherein the buffer has a double-buffer configuration that comprises a buffer for rendering a rendering image and a buffer out of which a rendering image that has been rendered is read, and the intermediate data scanning means is configured to detect, for each scan line separately, a graphic form that is included in the scan line from the intermediate data stored in the external memory,
wherein the graphic form rendering means is configured to render a rendering image for each scan line separately, and
wherein switching between the buffers, and scan line-by-scan line basis processing by the intermediate data scanning means and the graphic form rendering means are executed in time with a horizontally synchronized output from the display output means to the screen for display.

4. A graphics rendering device according to claim 1, wherein the intermediate data generating processing by the intermediate data generating means is executed in a vertical blank period during which transition to processing of a next frame takes place.

5. A graphics rendering device according to claim 1, wherein the execution of the intermediate data generating processing by the intermediate data generating means is staggered by one frame from the rendering and display processing executed by the intermediate data scanning means, the graphic form rendering means, and the display output means.

6. A graphics rendering device according to claim 1, wherein the intermediate data generating processing by the intermediate data generating means is executed at a frequency of once for every two or more frames.

7. A graphics rendering device according to claim 1, wherein the intermediate data generating processing is executed through software processing by a CPU.

8. A graphics rendering device according to claim 2,
wherein the buffer has a double-buffer configuration that comprises a buffer for rendering a rendering image and a buffer out of which a rendering image that has been rendered is read, and the intermediate data scanning means is configured to detect, for each scan line separately, a graphic form that is included in the scan line from the intermediate data stored in the external memory,
wherein the graphic form rendering means is configured to render a rendering image for each scan line separately, and
wherein switching between the buffers, and scan line-by-scan line basis processing by the intermediate data scanning means and the graphic form rendering means are executed in time with a horizontally synchronized output from the display output means to the screen for display.

9. A graphics rendering device according to claim 2, wherein the intermediate data generating processing by the intermediate data generating means is executed in a vertical blank period during which transition to processing of a next frame takes place.

10. A graphics rendering device according to claim 2, wherein the execution of the intermediate data generating processing by the intermediate data generating means is staggered by one frame from the rendering and display processing executed by the intermediate data scanning means, the graphic form rendering means, and the display output means.

11. A graphics rendering device according to claim 2, wherein the intermediate data generating processing by the intermediate data generating means is executed at a frequency of once for every two or more frames.

12. A graphics rendering device according to claim 2, wherein the intermediate data generating processing is executed through software processing by a CPU.
